(19) United States
(12) Patent Application Publication
(10) Pub. No.: US 2013/0234455 A1
(43) Pub. Date: Sep. 12, 2013

(54) HANDLE FOR A MOVABLE PANEL OF A VEHICLE INCLUDING AN INERTIAL BODY AND A FUSE

(71) Applicants: Antonio Rocci, Creteil (FR); Guillaume Lesueur, Creteil (FR)

(72) Inventors: Antonio Rocci, Creteil (FR); Guillaume Lesueur, Creteil (FR)

(73) Assignee: VALEO S.P.A., Santena (TO) (IT)

(21) Appl. No.: 13/822,827

(22) PCT Filed: Sep. 7, 2011
(86) PCT No.: PCT/EP11/04500

§ 371 Date: May 17, 2013

(30) Foreign Application Priority Data
Sep. 13, 2010 (IT) MI2010A001664

(51) Int. Cl. E05B 65/12

(52) U.S. Cl. CPC E05B 77/06
USPC 292/336.3

(57) ABSTRACT

The invention relates to a handle for a movable panel of a vehicle, including: an inertial body (18) capable of assuming a position in which the opening of the handle is blocked; and a part (12) capable of being broken or deformed when a member (6) for controlling the handle is urged with a degree of force exceeding a predetermined threshold, in order to enable the handle to be opened when the body is in the blocking position.

The invention concerns handles for movable panels of vehicles.

Movable panel handles are known equipped with an inertial system adapted, in the event of side impact and by virtue of the effect of the acceleration variation, to assume a locking position that inhibits the mechanism of the handle to prevent any unintentional opening of the movable panel, notably if the inertia of the impact tends to actuate an operating member of the handle.

There are known in particular reversible type inertial systems and non-reversible type inertial systems.

A reversible system reverts to the rest position after the impact. It has the advantage of allowing opening of the movable panel by means of the handle after the impact. However, it has the drawback of generally being highly sensitive to lateral accelerations in both directions as well as to rebounds. Accordingly, if variations in the direction of the acceleration occur during the impact, it can happen that the system returns to its rest position and renders the mechanism of the handle that was initially inhibited active again. This can lead to movement of the handle because of the effect of the impact and to opening of the movable panel.

A non-reversible inertial system remains in the locking position throughout and after the impact. It has the advantage of not being sensitive to acceleration variations during the impact or to rebounds. It is therefore certain that the handle mechanism is appropriately inhibited throughout the impact, so that the movable panel does not open. However, this system has the disadvantage that the handle mechanism remains inhibited after the impact and thus makes intentional opening of the movable panel by maneuvering the handle impossible.

An object of the invention is to combine the advantages of both types of system without their disadvantages.

To this end, the invention provides a handle for a movable panel of a vehicle, which includes:
an inertial mass capable of assuming a position of blocking opening of the handle, and
a part adapted to break or to be deformed because of the effect of applying a force to an operating member of the handle having an intensity exceeding a predetermined threshold to allow opening when the mass is in the locking position.

Thus the handle may comprise a non-reversible inertial device that enables impact, and although the mechanism remains a priori inhibited, it is possible to force the movable panel open by applying force to the actuating member so as to break or to deform the part, which thus forms a mechanical fuse. The movable panel can therefore be opened to enable an occupant to exit the vehicle. This handle combines the advantages of the systems of both the types mentioned above at the same time as alleviating their drawbacks.

The handle of the invention may also have at least one of the following further features:
the part is a lever of the handle;
the lever is adapted to transmit a movement of the operating member to an opening mechanism of the handle;
the lever is arranged to be in direct contact with the mass;
the threshold has a value of 500 newtons;
the part has a thinner preferential rupture area;
the thinner area is provided in a plane portion of the part;
the thinner area is U-shaped;
the handle includes a frame forming an abutment for the mass on rupture or deformation of the part; and
the handle is adapted to prevent the inertial mass moving from the locking position to a rest position allowing opening.

Other features and advantages of the invention will become more apparent in the course of the following description of an embodiment given by way of nonlimiting example with reference to the appended drawings, in which:

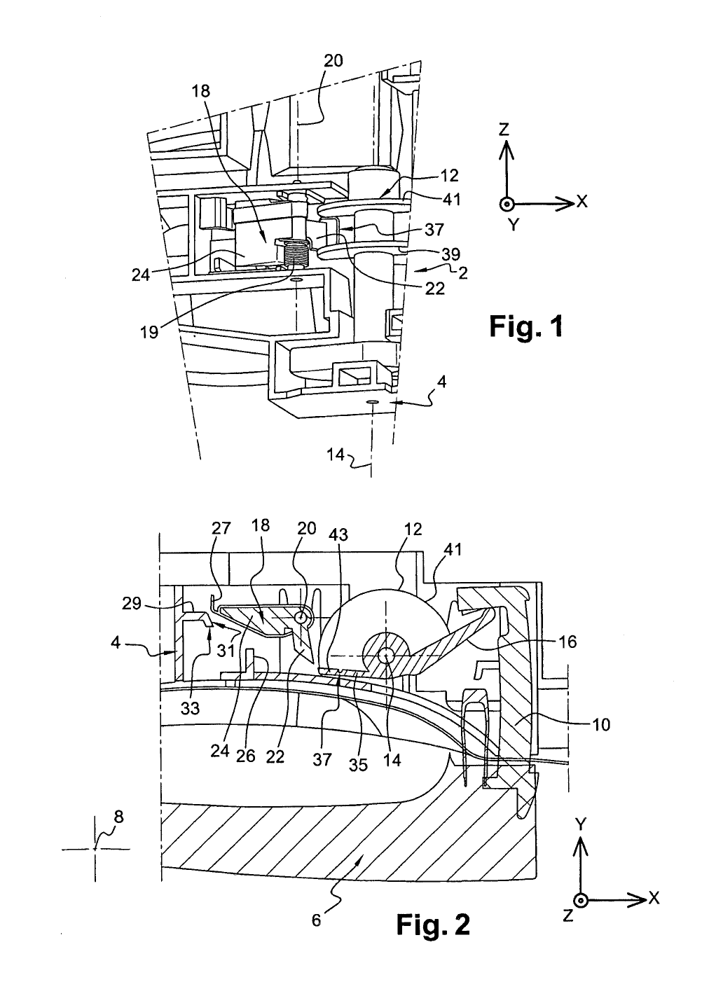

FIG. 1 is a partial perspective view of a mechanism of a handle in accordance with one embodiment of the invention; and

FIGS. 2 to 4 illustrate respective steps in the operation of this mechanism.

An automobile vehicle movable panel handle of one embodiment of the invention will be described hereinafter. The movable panel can be a front door, a rear door or a tailgate. Here reference is made to an external handle enabling maneuvering of the movable panel to unlock it and open it from outside the vehicle. The invention is nevertheless equally applicable to an internal handle for opening the movable panel.

There is used hereinafter the orthogonal system of axes XYZ in which the horizontal directions X and Y are respectively parallel and perpendicular to the direction of movement of the vehicle and the direction Z is vertical.

Referring first to FIGS. 1 and 2, the handle 2 includes a support or frame 4 rigidly fastened to the structure of the movable panel. It includes an external holding part 6 intended to be actuated manually by a user wishing to open the movable panel from outside the vehicle. Here this part 6 is articulated to the support 4 about a vertical shaft 8 by means known in themselves that are not described in detail here. The holding part 6 is extended inside the handle and the movable panel by an extension 10 extending in the direction Y.

The handle 2 includes a lever 12 mounted to be mobile in rotation relative to the support 4 about a vertical shaft 14. This lever notably includes an arm 16 on the trajectory of an edge of the extension 10 so that, when a user maneuvers the holding part 6 outwards in the direction Y, the extension 10 entrains the arm 16, which causes the lever 12 to turn.

The lever is connected in a manner that is not shown and that will not be described here to other parts of the handle mechanism, notably a traction cable. This mechanism serves to unlock the movable panel relative to the body of the vehicle.

The handle 2 also includes an inertial system including a part 18 forming a mass mounted to be mobile in rotation relative to the support 4 about a vertical shaft 20. This part includes two profiled portions 22 and 24 such that the part as seen in section in FIGS. 2 to 4 is generally V-shaped.

The mass 18 can occupy different positions about its shaft 20.

In the rest position shown in FIG. 2, the locking part 22 is not on the trajectory of the lever 12 and therefore allows it to rotate and enables the movable panel to be opened by manoeuvering the holding part 6.

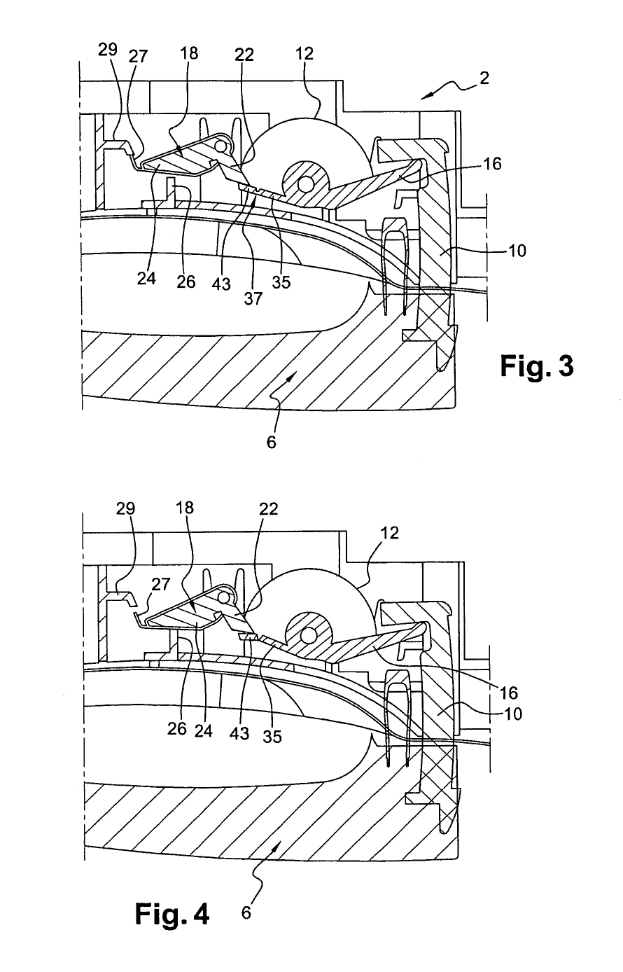

In the locking position shown in FIG. 3, the locking part 22 is on the trajectory of the lever 12, which it therefore prevents from turning, with the result that it inhibits the handle mechanism. The compression part 24 of the mass 18 bears against an abutment 26 rigidly fastened to the support 4. Because of this it holds the holding part 6 in position and prevents opening of the movable panel.

A spring 19 for returning the mass to its rest position bears on the one hand on the mass and on the other hand on the support 4. The compression part 24 has a mass greater than that of the locking part 22, so that if the mask is subjected to an acceleration in the direction Y toward the exterior of the vehicle, it pivots in the anticlockwise direction to move from the rest position to the locking position.

The free end of the locking part 24 carries a leaf spring 27 a proximal part of which is in line with the face of the locking part 24 facing outwards and a distal part of which is bent parallel to the direction Y when the mass 18 is at rest. The two parts of the leaf spring are parallel to the direction Z.

The frame 4 further includes an abutment 29 having a ramp face 31 and a stop face 33, both parallel to the direction Z. The ramp face is inclined relative to the direction X and faces the leaf spring 27 when the mass is in the rest position. The stop face 33 is perpendicular to the direction Y and oriented in the opposite direction to the leaf spring in the rest position of the mass.

The leaf spring 27 cooperates with the abutment 29 to form a ratchet device. When the mass moves from the rest position to the locking position, the leaf spring 27 comes to bear against the ramp 31 which has the effect of bending the leaf spring to enable it to pass the abutment 29. When the leaf spring reaches the face 33, it straightens elastically. The face 33 then forms an obstacle for the leaf spring 27 preventing the mass 18 from returning to the rest position. The face 33 is oriented in a plane perpendicular to that of the median fiber of the distal part of the leaf spring 27.

Other arrangements for retaining the inertial mass in the locking position may be envisaged, such as a ratchet wheel fastened to the inertial mass or a metal leaf spring dissociated from the inertial mass but receiving a lug of the inertial mass in an appropriate orifice when the latter mass is in the locking position.

The abutments 26 and 29 are rigid and therefore have negligible elasticity.

The lever 12 includes an arm or plate 35 by means of which it is adapted to come into direct contact with the locking part 22. The arm 35 has an essentially plane shape parallel to the axis 14 but not radial with respect thereto. The arm 35 has a constant thickness with the exception of a thinner area where it is intended it should break. This area 37 is U-shaped when the arm 35 is seen at rest in a plane in the direction Y. The lever 12 includes two disks 39 and 41 with axis 14 to which the arms 16 and 35 are rigidly fixed. The two branches of the U-shape are parallel to the disks and extend along respective disks. The base of the U-shape is parallel to the axis 14. The free ends of the branches are level with the free edge of the arm. The thinner area thus delimits a free end area 43 of the arm adapted to break. The lever, and more generally the handle, is configured so that the free end 43 breaks off only if a user exerts on the member 6 a force having an intensity exceeding a predetermined threshold. The latter threshold may be fixed at 500 newtons, for example.

The handle in accordance with the invention operates in the following manner.

FIG. 1 illustrates the handle with all the parts in the rest position. The locking part 22 is not on the trajectory of the lever and its compression part 24 is at a distance from the abutment 26. A user wishing to open the movable panel actuates the holding part 6 which through the extension 10 entrains the lever 12 in rotation about its axis to unlock the movable panel. The return spring 19 holds the mass 18 out of the trajectory of the lever 12 in order for the extension 10 to be able to entrain the latter freely.

Referring to FIG. 2, it is assumed that the vehicle suffers a lateral impact in the direction Y toward the outside and this impact is such that because of its inertia the holding part 6 begins to move because of its inertia toward the outside of the vehicle. The same applies to the inertial mass 18, which moves beforehand by turning in the anticlockwise direction relative to its FIG. 1 position until the leaf spring 27 clears the abutment 29. In the locking position reached in this way, the part 22 is on the trajectory of the lever 12 and prevents any additional rotation thereof, where necessary by coming to bear against the abutment 26, despite the force applied by the extension 10. The holding part is therefore retained in position against the force generated by the acceleration of the impact. This prevents any unintentional opening of the movable panel. Given that the leaf spring 27 now faces the face 33 of the abutment 29, the movement of the mass 18 from the rest position to the locking position is non-reversible, with the result that the mass remains in the locking position throughout and after the impact.

In FIG. 3 it is assumed that the impact phase has ended and that a user wishes to open the movable panel from the outside. They actuate the holding part 6, applying a force having an intensity exceeding the predetermined threshold. The extension 10 therefore causes the lever 12 to turn in the clockwise direction and thus to cause the inertial mass to turn in the anticlockwise direction. However, the latter mass comes to bear against the abutment 26. The loading of the arm 35 against the locking part 22 at the level of its free end area 43 causes the latter to break along the thinner area 37 as shown in FIG. 4. A sufficient amount is broken off the mass 18 not to be on the trajectory of the remaining part of the arm 35, enabling the latter to be turned in the clockwise direction by the force exerted on the holding part. This movement allows the movable panel to be opened.

The handle of the invention therefore has the advantage both of providing a non-reversible inertial system which therefore remains in the locking position throughout and after the impact and of allowing intentional opening of the movable panel after the impact under the control of a user.

Of course, numerous modifications may be made to the invention without departing from the scope of the invention.

The part adapted to break could be a part of the handle other than the lever 12. It could notably be the mass 18, for example at the level of its locking part 22.

The leaf spring 27 could be carried by the frame and the abutment 29 could be carried by the mass 18.

The fuse part could equally be adapted not to break but to deform, provided this is sufficient to allow opening of the movable panel when the mass occupies the locking position.

The threshold value of 500 newtons is given by way of example only. This threshold may be increased or reduced. It is a matter of determining a threshold that prevents unintentional opening of the movable panel because of the effect of the inertial movement of the holding member but allows intentional opening of the movable panel by manipulating that member.

1. A handle for a moving panel of a vehicle, comprising:
an inertial mass configured to assume a position of blocking opening of the handle; and
a part configured to deform or break because of an effect of applying a force to an operating member of the handle having an intensity exceeding a predetermined threshold to allow opening when the inertial mass is in a locking position.

2. The handle as claimed in claim 1, wherein the part is a lever of the handle.

3. The handle as claimed in claim 1, in which the lever is configured to transmit a movement of the operating member to an opening mechanism of the handle.

4. The handle as claimed in claim 2, wherein the lever is arranged to be in direct contact with the mass.

5. The handle as claimed in claim 1, wherein the threshold has a value of 500 newtons.

6. The handle as claimed in claim 1, wherein the part has a thinner preferential rupture area.

7. The handle as claimed in claim 6, wherein the thinner area is provided in a plane portion of the part.

8. The handle as claimed in claim 6, wherein the thinner area is U-shaped.

9. The handle as claimed in claim 1, further comprising a frame forming an abutment for the mass on rupture or deformation of the part.

10. The handle as claimed in claim 1, wherein the handle is configured to prevent the inertial mass moving from the locking position to a rest position allowing opening.
